(19) United States
(12) Patent Application Publication
(10) Pub. No.: US 2026/0280706 A1
(43) Pub. Date: Sep. 17, 2026

(54) AN OPTICAL WIRELESS COMMUNICATION SYSTEM

(71) Applicant: SIGNIFY HOLDING B.V., Eindhoven (NL)

(72) Inventors: MICHEL GERME, CORMELLESLE ROYAL (FR); PHILIPPE SIMON, VELDHOVEN (NL)

(21) Appl. No.: 19/469,488

(22) PCT Filed: Mar. 22, 2024
(86) PCT No.: PCT/EP2024/057821

§ 371 Date: Sep. 26, 2025

(30) Foreign Application Priority Data
Mar. 31, 2023 (EP) 23165968.1

(51) Int. Cl. H04B 10/116; H04B 10/50; H04J 14/02

(52) U.S. Cl. CPC H04B 10/116; H04B 10/506; H04J 14/0298; H04J 14/03

(57) ABSTRACT

The invention provides an OWC system (100), an OWC transmitter (10) and an OWC receiver (50) aimed at a power efficient optical wireless communication solution. To this end an OWC system (100) is proposed to transmit a bipolar first data signal (40), such as a 10BASE-T or a 100BASE-TX ethernet signals as customary used for twisted pair ethernet, by mapping the positive and negative components of the bipolar signal (40) onto two unipolar drive signals (22, 32), for driving two separate light sources (20, 30) operating at different wavelengths (12, 13). In this manner facilitating a low-cost, low-complexity power efficient signal transmission method that provides a wavelength division multiplex of a bipolar signal, a system that allows reconstruction of the bipolar first data signal (40) at the OWC receiver side, by wavelength division demultiplexing of the transmitted components and re-combining the negative and positive components at the receiver side.

### FIELD OF THE INVENTION

This invention relates to Optical Wireless Communication, OWC, systems, OWC transmitters and OWC receivers as well as method for OWC transmission and reception.

### BACKGROUND OF THE INVENTION

Li-Fi (Light Fidelity) is a new type of Optical Wireless Communication (OWC), which also includes Free Space Optical (FSO) communication and Visible Light Communication (VLC). OWC (and hence Li-Fi, FSO and VLC) use light as a media of communication, for replacing cable wire (wireline) communication.

Light based wireless communication offers the ability for high data rate communication, for example even exceeding 10 Gbit/s, for devices having a line of sight between them. This for example applies to a set of communicating devices within an office environment.

Known Li-Fi products rely on a grid of optical access points mounted in the ceiling. The beams of these access points are wide enough (and thereby have a large field of view and/or coverage area) to create an overlap with the neighboring access points at the level of the desks beneath. The receiving devices in such a system are typically located at the desks or are being held by hand at a height close thereto.

United States patent application US2022/0166506 A1 for example discloses an OWC system and method whereby transmissions that make use of multiple wavelengths are received at the receiver and filtered using a dual-wavelength filter configured to pass light of a first and second wavelength but block light of a third wavelength—and a photodetector configured to receive the filtered light and to sense modulated light of the first wavelength and second wavelength-when present-to produce a receiver signal.

For ease of installation, the grid of access points is for example aligned with the luminaire grid in the ceiling. Each access point in such an installation must reach (illuminate, in the case of visible light) several square meters and hence illuminates a significant conical area. Such installations may utilize illumination light for the downlink (to the end devices) and may use infrared light for the uplink (towards the access point) so as not to disturb mobile device users. Alternatively, both downlink and uplink may utilize infrared light thereby at least partially disentangling the lighting and communication infrastructure.

To communicate with the access points, a dongle may be connected to an end device, which is a user device such as a laptop or tablet. These dongles also emit a similar broad beam to be sure that at least one access point will receive the signal from the dongle. Alternatively, as Li-Fi is being adopted, such the dongle hardware may become an integral part of such end device. In such office applications, generally the beams of the access points and the dongles are fixed in direction, so no adjustment of the beam direction is required.

Each access point comprises a modem connected to one or multiple transceivers. The user devices connect to the access point via an optical link and they also comprise a modem connected to one or multiple transceivers.

The function of the modem is to handle the protocols (modulate and demodulate) for transmitting and receiving data over the visible or invisible light connection. The modem transmitter includes an optical frontend which transforms an electrical signal of the transmit data to an optical signal (for example using an LED) and the modem receiver transforms the optical signal to an electrical receive data signal (using a photodiode).

By way of example, the Trulifi 6002 system of Signify has a modem, that has at most six transceivers (also called LAP), for communication with sixteen dongles (also called LAK). The connections between the modem and transceivers are wired (copper or optical fiber based). The connections between the transceivers and the dongles are optical wireless connections. For the data transmission in this system, an optical Time Division Multiple Access (TDMA) is used and the signal transmitted is within the Intermediate Frequency (IF) in the range 0 MHz to 200 MHz. For optical communication, the wavelength used is Infrared, but may also be any other wavelength from 200 nm to 2200 nm. Depending on the distance between the access point and dongle, speed in sense of bitrates of 200 Mbps can be reached.

Signal and power for the dongle are typically interfaced through a USB C connector towards the end of the dongle. Serial data from the USB port is interfaced through reduced gigabit media-independent interface (RGMII) signals towards the baseband of the dongle which performs the signal processing from analog Orthogonal Frequency Division Multiplexing (OFDM) to digital, and the other way around. Conditioning (e.g. amplification, buffering etc.) of the OFDM signal is done by an Analog Front End (AFE). The output and input of the AFE enters the Optical Front End (OFE) where a modulator modulates the LED current (thereby the optical signal) and a Photodetector (PD) circuit converts the received optical signal into an electrical signal.

The access point (i.e. the modem) has similar functionality to the dongle, except that the signals of the optical front end are distributed to the six transceivers.

Furthermore, the modem is supplied directly from the mains and interfaces the data through Ethernet. The transceivers are in the sensor slots of luminaires and are powered by the modem.

When in an OWC system, data needs to be transmitted that is provided over a twisted pair ethernet link using 10BASE-T or 100Base-TX encoding, the data may be extracted and modulated in a variety of manners for optical transmission. A popular method for optical wireless transmission uses Intensity Modulated/Direct Detection, IM/DD. An example of such an IM/DD method is G.vlc (also known as ITU-T G.9991). G.vlc makes use of DCO-OFDM modulation, a form of modulation wherein the OFDM signal is super imposed on a DC off-set signal in order to obtain a positive unipolar OFDM signal suitable for driving light sources such as LEDs, or VCSELs.

### SUMMARY OF THE INVENTION

However, when such data needs to be transmitted in an energy efficient manner, G.vlc might not be the best solution. Commercially available G.vlc modems consume a considerable amount of power, power which will add to the power used to drive the light sources for communication. As a result, G.vlc may this not be the best candidate for power efficient realization of such an optical link.

In order to avoid the need for a power-hungry modulator, one might consider the use of an On/Off Keying (OOK) scheme. When there is a need to transmit a 10BASE-T and/or 100BASE-TX one might consider mapping the bipolar modulated signal in its entirety onto an optical drive signal. To this end one could add an offset to the signal to create a unipolar signal. Adding an offset means, as shown in FIGS. 3A and 3B, that the +V and −V voltage levels of a 10BASE-T would be mapped onto a drive current of A+Δ and A−Δ respectively. Considering that a 10BASE-T signal is a DC-free signal, adding an offset means that the average LED current would amount to A. Consequently, the light source used for transmission would be powered continuously, which is considered suboptimal.

The invention provides an alternative that can be more energy efficient. The invention is defined by the claims.

In accordance with a first aspect an Optical Wireless Communication, OWC, system is disclosed comprising an OWC transmitter and an OWC receiver. Here the OWC transmitter comprises: a first light source arranged to transmit light at a first wavelength; and a second light source arranged to transmit light at a second wavelength, the first wavelength and the second wavelength being different wavelengths; a first light source driver arranged to generate a positive unipolar first drive signal for driving the first light source, by mapping a first unipolar half of a bipolar modulated first data signal onto a positive unipolar signal, thereby generating the first drive signal, the first unipolar half of the bipolar modulated first data signal occupying a first bandwidth range below a first frequency; a second light source driver arranged to generate a positive unipolar second drive signal for driving the second light source, by mapping a second unipolar half of the bipolar modulated first data signal onto a positive unipolar signal, thereby generating the second drive signal. The OWC receiver in turn comprises: a first light transducer arranged to detect light at the first wavelength and generate a first electrical detection signal; and a second light transducer arranged to detect light at the second wavelength and generate a second electrical detection signal, a first signal reconstruction unit arranged to generate a first received signal, the first signal reconstruction unit arranged to combine: the first electrical detection signal within the first bandwidth range below a first frequency as a first component with a first polarity with the second electrical detection signal as a second component with a second polarity, the first polarity opposite to the second polarity, thereby forming the first received signal for output by the OWC receiver.

In accordance with a second aspect, an Optical Wireless Communication, OWC, transmitter is provided for use in an Optical Wireless Communication system comprising with an OWC receiver, the OWC transmitter comprising: a first light source arranged to transmit light at a first wavelength; and a second light source arranged to transmit light at a second wavelength, the first wavelength and the second wavelength being different wavelengths; a first light source driver arranged to generate a positive unipolar first drive signal for driving the first light source, by mapping a first unipolar half of a bipolar modulated first data signal onto a positive unipolar signal thereby generating the first drive signal, the first unipolar half of the bipolar modulated first data signal occupying a first bandwidth range below a first frequency a second light source driver arranged to generate a positive unipolar second drive signal for driving the second light source, by mapping a second unipolar half of the bipolar modulated first data signal onto a positive unipolar signal, thereby generating the second drive signal.

In accordance with a third aspect an Optical Wireless Communication, OWC, receiver is provided for use in an OWC system with an OWC transmitter, the OWC receiver comprising: a first light transducer arranged to detect light at a first wavelength and generate a first electrical detection signal; and a second light transducer arranged to detect light at a second wavelength different from the first wavelength and generate a second electrical detection signal, a first signal reconstruction unit for generating a first received signal, the first signal reconstruction unit arranged to combine: the first electrical detection signal within a first bandwidth range below a first frequency as a first component with a first polarity with the second electrical detection signal within the first bandwidth range below a first frequency as a second component with a second polarity, the first polarity opposite to the second polarity, thereby forming the first received signal for output by the OWC receiver.

The OWC transmitter in accordance with the first aspect and the second aspect maps the positive components of the bipolar modulated first data signal onto the first unipolar driving signal and the negative components of the bipolar modulated first data signal onto the second unipolar driving signal. The first and second drive signals in turn are used to drive two light sources that emit a first and a second wavelength respectively, wavelengths that are different from one another. This means the positive and negative components of the first bipolar modulated first data signal are mapped on different wavelengths. As the input signal is either positive or negative, only one of the two light sources will be driven at any moment in time.

The proposed approach is a special wavelength division multiplexing scheme that maps the bipolar signal onto two unipolar signals. This in turn provides a very simple and low-cost solution that does not require a costly and power-hungry baseband OFDM modem, to transfer the data in a more energy efficient manner than using G.vlc or adding a DC-offset to the 10BASE-T signal. Reduced power dissipation means more freedom in the housing design and benefits potential for miniaturization.

The claimed invention has a further advantage, when the input signal in idle mode defaults to a 0 Volt input level, as then the first and second unipolar drive signal default to zero as well. This means that when data is supplied using a 10BASE-T or a 100Base-TX signal, the energy dissipation during idle periods is further reduced as these signals respectively use a Manchester line code in accordance with IEEE 802.3i-1990 and a 100Base-TX using a Multi-Level Transmit-3 line code, also known as MLT-3, in accordance with IEEE 802.3u-1995.

On the receiving end, the OWC receiver in accordance with the first aspect may, when in line of sight of the OWC transmitter, receive the light emitted by the OWC transmitter. The first and second light transducer of the OWC receiver will then receive light as emitted by the first and second light source respectively. Here the use of different wavelengths allows for efficient separation at the OWC receiver. Different implementations may be used to achieve this. For example, when using two broadband light transducers capable to receive a wavelength range including the first and second wavelength, it may be possible to separate the wavelengths by placing an appropriately narrow wavelength selective filter in front of the respective transducers, thereby allowing proper separation. Alternatively, it may be possible to use two different dedicated narrowband light transducers that have a sufficiently narrowband wavelength sensitivity to make do without separate wavelength selective filter.

The first and second transducers thus each generate a respective unipolar signal that corresponds to either the positive or the negative components from the original bipolar modulated first data signal. The first signal reconstruction unit subsequently combines the two electrical detection signals into the first received signal, by mapping the two unipolar signals received at different wavelengths-as first and second polarity components of the first received signal.

This reconstruction may be performed either in the analog or in the digital domain, depending on the application requirements. Preferably, the first signal reconstruction unit is arranged to reconstruct a bipolar modulated first data signal, when present, using a priori knowledge of the bipolar modulation. An example of a preferred solution uses a bipolar modulated first data signal that is encoded as one of: a 10BASE-T signal that using a Manchester code in accordance with IEEE802.3i-1990, and a 100BASE-TX using a Multi-Level Transmit-3 line code, MLT-3 in accordance with IEEE 802.3u-1995.

For example, when the signal transmitted is a 10BASE-T signal, and the OWC receiver is arranged to output the first received signal over a twisted pair as an analog signal, it may be advantageous to perform the reconstruction in the analog domain. In this case, because the line code is a Manchester code, the output signal will have three discrete output levels (+V, −V and 0V for idle). In this case the received unipolar signals may be passed through a slicer or limiter, that differentiates between two unipolar levels, and in doing so remove noise and sharpens edges, prior to combining.

Alternatively, reconstruction may be performed in the digital domain, in which case the signal may be recovered by first performing clock recovery as customary for Manchester line codes and then sampled at positions where the signal is stable (avoiding sampling near the clock edges, so as to prevent the introduction of glitches, and subsequently regenerating an in-specification 10BASE-T signal using the recovered clock and data. For 100BASE-TX a similar approach may be applied.

In accordance with a first option of the OWC transmitter of the first or second aspect, the first light source driver for generating the first drive signal is arranged to combine, the first unipolar half of the bipolar modulated first data signal mapped on a positive unipolar signal with a unipolar OFDM modulated second data signal located in a second bandwidth range above the first frequency.

The first option of the OWC transmitter of the first or second aspect further extends the functionality of the OWC transmitter of the first and second aspect, by re-using the hardware of the OWC transmitter to additionally transmit a (unipolar) optical OFDM signal via the first light source in a frequency division multiplex. This first option is particularly advantageous in situations where there is a need for a continuous availability of an ethernet link, and an occasional need for more advanced communication.

Using this approach, it is possible to implement a low-power, point-to-point optical wireless ethernet link, that even in the absence of advanced power-down mechanisms is low-power, as the idle mode defaults onto a low-power state. Thereby enabling a low-power-high-availability optical link that may be complemented on an “as-needed-basis” by a more advanced communication scheme, such as G.vlc (ITU-T G.9991) that caters for point-to-multipoint communication when so required.

Continuous low-power links may find application, in field hospitals, or mobile command centers for first responders. The continuous availability of a low-power optical communication system may be required for external communication, whereas the high-speed point-to-multi-point connections may facilitate the occasional making available of high-speed connectivity to a plurality of transceiver devices.

In accordance with the first option of the OWC transmitter, the first light source is driven with a combination of the first unipolar half of a bipolar modulated first data signal and the unipolar OFDM modulated second data signal. When the first light source is an LED, preferably the first light source is operated in the linear range, as this allows for higher data rates for the unipolar OFDM modulated second data signal. This means that the resulting combined signal will need to be mapped onto the linear output range of the first light source. This also means that it is possible to allocate a larger part of the energy to either the transmission of the bipolar modulated first data signal, or the unipolar OFDM modulated second data signal by weighting the respective contributions.

Preferably, the OWC transmitter in accordance with the first option further comprises a first OFDM modulator arranged to generate the unipolar OFDM modulated second data signal through the application of bit-loading in the OFDM modulator, and where no bits are loaded on the OFDM subcarriers within the first bandwidth range. In an OWC system that uses G.vlc, advantageously, the first bandwidth range may be in the range of 0 to 20 MHz, and the second bandwidth range may be from 20 to 40 MHz or 20 to 100 MHz.

The above bit-loading approach is preferably combined with shaping of the OWC transmitters transmit power spectral density. Various techniques may be applied to perform shaping of the transmit power spectral density. Examples of such techniques, as used in G.hn and G.vlc may be found in ITU-T G.9964, which includes techniques such as sub-carrier masking, also referred to as notching—which sets the transmit power of select subcarriers to zero. Power spectral density shaping allowing the specification a piece wise linear power spectral density shaping mask.

The OWC transmitter according to the first option, is preferably combined with an OWC receiver in accordance with a first option or a second option as described below.

In accordance with a first option of the OWC receiver of the first or third aspect, the OWC receiver further comprises a second signal reconstruction unit, the second signal reconstruction unit arranged to pass the first electrical detection signal within the second bandwidth range above the first frequency to an OFDM demodulator, the OFDM demodulator arranged to retrieve a second received signal, when present, from the first electrical detection signal within the second bandwidth range by demodulating the OFDM modulation, thereby forming the second received signal for output by the OWC receiver.

In accordance with the first option of the OWC receiver, the first transducer of the OWC receiver is arranged to leverage the fact that the unipolar OFDM modulated second data signal is frequency division multiplexed with the first unipolar half of a bipolar modulated first data signal. As a result, these signals may be separated on the OWC receiver end by appropriate filtering. At the transmitter side, the OFDM modulator limits the bandwidth of the OFDM signal and only loads bits in the second bandwidth range, through the application of bit-loading. On the receiver side, the OFDM demodulator, may be adapted to disregard energy in the first bandwidth range, which in case of certain OFDM modulation technologies such as G.vlc is supported in the communication protocol itself.

In case of G.hn and G.vlc the standard allows for so-called “spectrum notching”, as described in ITU-T G.9964 and allows OWC transmitters to share information on the Transmit Power Spectral Density (TxPSD) in Medium Access Plan (MAP) messages. By doing so the OWC transmitter may signal the TxPSD towards any OWC receivers receiving the signal. The OWC receivers in turn may advantageously apply a corresponding band-stop/notch filter to reduce unwanted signals to interfere with the demodulation process. Although the above finds application in G.vlc capable devices, it will be clear to those skilled in the art that similar signaling schemes may also be deployed elsewhere. Moreover, where the communication protocol in question does not support spectral notching, it may still be possible to pre-configure devices for operation in this manner, by pre-configuring the transmit power spectral density and by pre-configuring a band-stop filter, without signaling support from the protocol, even though such pre-configuring might break compatibility.

Preferably, the second signal reconstruction unit is arranged to attenuate and/or filter out signal components of the first electrical detection signal in the first bandwidth range. Likewise the first signal reconstruction unit may be arranged to attenuate and/or filter out any DC components and/or signal components in the second bandwidth range.

In accordance with a second option of the OWC receiver of the first or third aspect, the OWC receiver further comprises a third light transducer arranged to detect light at the first wavelength and light at the second wavelength and generate a third electrical detection signal; a third signal construction unit, the third signal reconstruction unit arranged to pass the third electrical detection signal to an OFDM demodulator, the OFDM demodulator arranged to retrieve a third received signal, when present, from the third electrical detection signal within a second bandwidth range by demodulating the OFDM modulation, thereby forming the third received signal for output by the OWC receiver.

The OWC receiver of the second option is provided with a third transducer capable of receiving light from both light sources. The third electrical detection signal thus will incorporate signal contributions from both light sources. Advantageously this means that the DC offset present in both the first drive signal and the second drive signal will be cancelled when both signals are balanced at the transmitter and the receiver trains for both wavelengths are properly calibrated. Optionally, a signal processing stage is provided to attenuate or remove noise in the third electrical detection signal outside the second bandwidth range. In this manner, the influence of noise originating outside the second bandwidth, on processing steps, such as an adaptive gain control can be minimized.

Advantageously, the unipolar OFDM modulation used within the OWC system, the OWC transmitters, the OWC receivers, and the transmit assemblies (described herein below) is selected from the set of DCO-OFDM, ACO-OFDM, Flip-OFDM, ADO-OFDM and HACO-OFDM. Out of the above set DCO-OFDM is used most often as it allows for reuse, of OFDM modulators that have been developed for radio-frequency and/or power-line modulation, however, a large number of unipolar OFDM modulation schemes has been developed as demonstrated by the paper “A Comparative Study of Unipolar OFDM Schemes in Gaussian Optical Intensity Channel”, by Jing Zhou, et al. in IEEE Transactions on Communications (Volume: 66, Issue: 4, April 2018) .

In accordance with a fourth aspect a first OWC transmit assembly is provided comprising an OWC transmitter in accordance with the second aspect and a first OFDM modulator arranged to generate the unipolar OFDM modulated second data signal through the application of bit-loading in the first OFDM modulator, and where no bits are loaded on the OFDM subcarriers within the first bandwidth range and a first electrical or optical wireline interface coupled to the first OFDM modulator arranged to transmit the unipolar OFDM modulated second data signal to the OWC transmitter for transmission.

The first OWC transmit assembly in accordance with the fourth aspect partitions the system in the first OFDM modulator (which may be a modulator/demodulator, or modem) component and an active OWC transmitter front-end. This advantageously means that the actual conversion from the electrical to the optical domain takes place at the point of transmission and thus allows the OWC transmitter to be integrated in luminaires, or in ceiling units, where power is readily available.

In accordance with a fifth aspect a second OWC transmit assembly, is provided the second OWC transmit assembly comprising: an optical front-end arranged to pass light received from a second optical wireline interface towards a coverage area by means of a lens; the second optical wireline interface for transmitting light from a coupler, to an optical front-end, a second OFDM modulator arranged to generate the unipolar OFDM modulated second data signal through the application of bit-loading in the second OFDM modulator, and where no bits are loaded on the OFDM subcarriers within the first bandwidth range; and an OWC transmitter in accordance with the first option of the second aspect, the OWC transmitter further comprising the coupler, arranged to couple the light from the first light source and light from the second light source into the second optical wireline interface.

The second OWC transmit assembly in accordance with the fifth aspect differs from that of the fourth aspect, in that it partitions the OWC transmit assembly in a different manner; all active transmit components are located in the OWC transmitter and the light output from the light sources is first combined and distributed to the passive optical frontend by means of the second optical wireline interface, which preferably is a so-called Plastic Optical Fiber, or POF. The advantage of this partitioning is that when deployed in settings such as emergency hospital tents, it allows for placement of the transmitter near the tent posts, where the transmitter may be hooked up with POFs that have been attached to the tent posts as an integral part of the emergency hospital tent. The passive optical front-end can be housed in a protective metal housing suspended from the tent ceiling, such that, as a result of proper weighting of the passive optical front-end, the optical front end will face downward and will be able to provide proper coverage within a region of the tent.

Optionally, there can also be a receive path, but in that case the optical front-end would need to include active components as well, so as to power an OWC receiver located in the optical front-end. In this case preferably, the wireline interface would also provide power, as well as an optical or electrical receiver path.

The light sources in the OWC system, OWC transmitters, OWC transmitter assemblies are preferably selected from the set of: Light Emitting Diodes (LED), laser diodes, vertical cavity surface emitting lasers (VCSEL), or edge-emitting laser diodes.

The transducers in the OWC system and/or OWC receiver are preferably selected from the set of: photodiodes, phototransistors, avalanche photodiodes and silicon photo-multipliers.

In accordance with a sixth aspect a method is provided of transmitting a first Optical Wireless Communication signal, the method comprising: generating a positive unipolar first drive signal, the first drive signal comprising a first unipolar half of a bipolar modulated first data signal, the first unipolar half of the bipolar modulated first data signal occupying a first bandwidth range below a first frequency generating a positive unipolar second drive signal, the second drive signal based on a second unipolar half of the bipolar modulated first data signal; driving a first light source with the first drive signal for transmitting light at a first wavelength; and driving a second light source with the second drive signal for transmitting light at a second wavelength, the first wavelength and the second wavelength being different wavelengths.

As will be clear to those skilled in the art, the method in accordance with the sixth aspect may be extended in a similar manner to that described hereinabove for the OWC transmitter of the second aspect.

In accordance with a seventh aspect a method of receiving a second Optical Wireless Communication signal the method comprising: generating a first electrical detection signal using a first light transducer arranged to detect light at a first wavelength but not a second wavelength; generating a second electrical detection signal using a second light transducer arranged to detect light at the second wavelength but not the first wavelength different from the first wavelength generating a first received signal by combining the first electrical detection signal within a first bandwidth range below a first frequency as a first component with a first polarity with the second electrical detection signal within the first bandwidth range below a first frequency as a second component with a second polarity.

As will be clear to those skilled in the art, the method in accordance with the seventh aspect may be extended in a similar manner to that described hereinabove for the OWC receiver of the third aspect.

### Enchancing the OWC Transmitter/OWC Receiver to Transmit Two Unipolar OFDM Signals

Optionally the OWC transmitter in accordance with the first option is extended so that it can embed a unipolar OFDM modulated second data signal in the output of a first light source as a frequency division multiplex as described above, but also embeds a unipolar OFDM modulated third data signal in the output of the second light source as a frequency division multiplex in a manner similar to that described above.

In order to recover both OFDM signals at the receiver-side, the light transducers need to be fitted with wavelength selective filters, so as to be able to perform the wavelength division demultiplexing. Wavelength demultiplexing is thus effectuated in the optical domain. Once the wavelength separation is sorted, this is followed by the frequency division demultiplexing in the electrical domain by passing copies of the signal to respective reconstruction units and by applying appropriate filtering. Once the frequency division demultiplexing has been completed the bipolar modulated first data signal (e.g. the 10BASE-T or 100BASE-TX bipolar first data signal) may be reconstructed using the two unipolar components in the first bandwidth range (below the first frequency). Meanwhile the second and third data signal may be demodulated using the respective unipolar components in the second bandwidth range (above the first frequency) either using two (or a time-multiplexed) SISO OFDM demodulator, or a 2-channel MIMO demodulator.

### Enchancing the OWC Transmitter/OWC Receiver Two Bipolar Signals

Optionally the OWC transmitter in accordance with the second aspect is enhanced in a different manner by multiplexing a bipolar modulated first data signal with a second bipolar OFDM modulated data signal. In this situation, the positive components of the bipolar modulated first data signal in the first bandwidth range and the positive components of the bipolar modulated OFDM second data signal in the second bandwidth range are combined into a frequency division multiplexed unipolar first driving signal for a first light source outputting light at a first wavelength.

In parallel the negative components of the bipolar modulated first data signal in the first bandwidth range and the negative components of the bipolar modulated OFDM second data signal in the second bandwidth range are combined into a frequency division multiplexed unipolar second driving signal for a second light source outputting light at a second wavelength. Both signals are subsequently transmitted and passed-on towards a first and second light transducer of a OWC receiver. The OWC receiver uses the first light transducer to receive light at the first wavelength, but not the second wavelength, and the second light transducer to receive light at the second wavelength, but not the first wavelength. The transducers thus separate the wavelength division multiplex in the optical domain. As described before, frequency division demultiplexing is then applied in the electrical domain. Here, a first reconstruction unit is arranged to combine positive and negative components in the first bandwidth range to reconstruct a first received signal, being a reconstruction of the first bipolar modulated first data signal, which e.g. may be a 10BASE-T or 100BASE-TX signal. A second reconstruction unit in turn is arranged to combine the positive and negative components of the received electrical signals in the second bandwidth range into a reconstructed bipolar OFDM signal and feed the reconstructed bipolar OFDM signal to an OFDM demodulator, thereby recovering a second received signal.

It is noted that the above apparatuses may be implemented based on discrete hardware circuitries with discrete hardware components, integrated chips, or arrangements of chip modules, or make use of signal processing devices or chips controlled by software routines or programs stored in memories, written on a computer readable media, or downloaded from a network, such as the Internet.

It shall be understood that the OWC system of claim 1, the OWC transmitter of claim 2, the OWC receiver of claim 9, the OWC transmit assembly of claims 7 and 8, and the method of claims 15 and 16 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1A shows a block diagram of an exemplary OWC system with a unidirectional communication path;

FIGS. 1B, 1C and 1D show graphs illustrating the construction of the first and second drive signal;

FIGS. 1E, 1F and 1G show graphs illustrating the generation of the first received signal;

FIG. 2A shows a block diagram depicting an exemplary OWC receiver path;

FIG. 2B shows a block diagram depicting an exemplary OFDM demodulator path of a OWC receiver;

FIGS. 3A and 3B show graphs illustrating mapping of a bipolar input signal onto a light source drive signal;

FIGS. 4A, 4B show timing diagrams of exemplary Manchester and MLT-3 line code;

FIGS. 4C, 4D shows exemplary timing diagrams of the idle period for 10BASE-T and 100BASE-TX signals.

FIG. 5A shows a block diagram of a further exemplary OWC system having a unidirectional communication path;

FIGS. 5B, 5C and 5D depicts energy distributions of various signals;

FIG. 6 shows a block diagram of an exemplary OWC system having a bidirectional communication path;

FIG. 7 shows a block diagram of an exemplary transmit assembly; and

FIG. 8 shows a block diagram of a further exemplary OWC system having a unidirectional communication path.

### DETAILED DESCRIPTION OF THE EMBODIMENTS

The invention will be described with reference to the Figures.

Figures are merely schematic and are not drawn to scale. It should also be understood that the same reference numerals are used throughout the Figures to indicate the same or similar parts.

Various embodiments of the present invention are described in the following based on an OWC system. Although the present invention is advantageous within the context of an OWC system, the invention is not limited thereto and such OWC systems may also be integrated with or in an illumination system.

Throughout the following, a light source may be understood as a radiation source that generates visible or non-visible light (i.e., including infrared (IR) or ultraviolet (UV)) light sources) for communication purposes. Although it may be beneficial to embed a communication signal in visible illumination lighting, preferably the uplink uses invisible light. As illumination lighting, as a result from the use of phosphor coated LEDs, may impose additional bandwidth limitations, it is not uncommon to use infrared for both uplink and downlink, as it also enables communication to operate fully independent from illumination. When using infrared light for communication, preferably wavelengths such as 850 nm and 940 nm may be used, but it will be clear to those skilled in the art that alternative wavelength within the infrared spectrum can be used.

The invention aims to transmit a bipolar modulated first data signal from an OWC transmitter to an OWC communication receiver. Although in radio frequency systems, the transmission of positive and negative signals is common practice, the situation is slightly more complex for intensity modulated OWC transmitters, as these cannot transmit negative signals.

When tasked with the problem of transmitting a bipolar modulated first data signal, a solution may be to map the required dynamic range of the bipolar input signal onto a, preferably linear, range of the light source. An example of such a mapping is depicted in FIGS. 3A and 3B, where 3A shows a graph depicting a signal using a Manchester line-code (such as used in 10BASE-T system), which may be mapped onto a unipolar drive signal of an LED, by adding a DC-offset A. The voltage levels −V and +V of the line code may then be mapped to respective LED drive current ILED values A−Δ and A+Δ as shown in FIG. 3B.

However, adding a DC-offset implies that when the system is at idle, which would correspond with the OV level of the Manchester line-code, the LED light source would be driven at the DC-offset current A, thereby continuously emitting light and continuously dissipating power.

An alternative solution would be to use a more advanced modulation technique such as ITU-T G.9991 (G.vlc), but that would result in additional cost and power dissipation resulting from the use of the base-band modulator. Use of G.vlc, which uses DCO-OFDM, would furthermore also suffer from the use of a DC-offset.

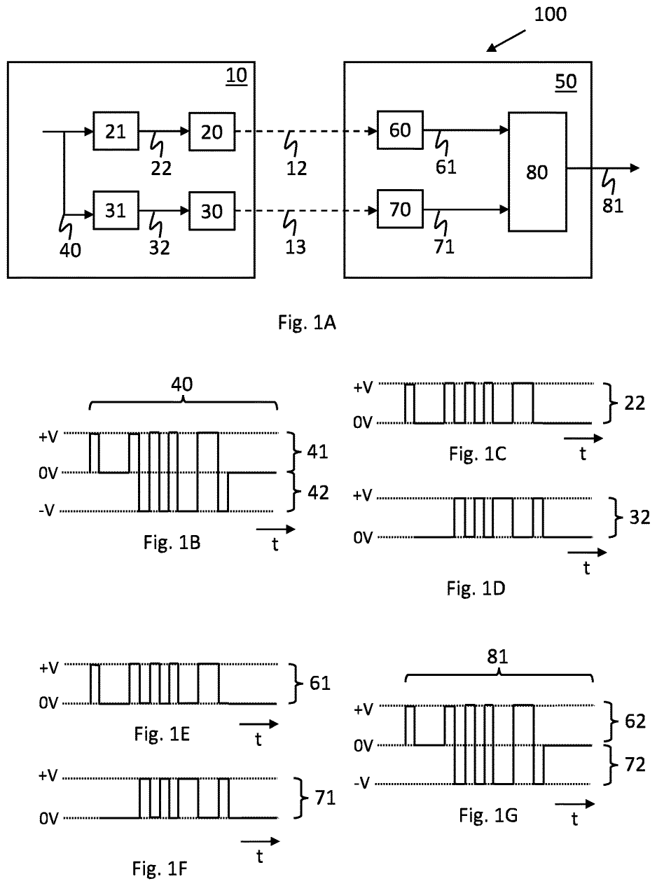

Referring now to FIG. 1A, which shows a block diagram of an exemplary OWC system 100 with a unidirectional communication path that provides an alternative, more power efficient solution. On the left-hand side we see OWC transmitter 10 that is arranged to communicate with OWC receiver 50 on the right. The OWC transmitter 10 is arranged to transmit a bipolar modulated data signal 40, which may be generates at the OWC transmitter 10, or that may be provided by an external source to the OWC transmitter 10 for transmission. The OWC transmitter 10 comprises a first light source 20 arranged to transmit light at a first wavelength 12; and a second light source 30 arranged to transmit light at a second wavelength 13, the first wavelength 12 and the second wavelength 13 being different wavelengths.

The OWC system of FIG. 1A maps the positive and negative components of the bipolar modulated data signal 40 onto two unipolar drive signals, one for each respective light source thereby creating a wave-length division multiplex that encompasses the bipolar modulated data signal 40.

To this end the OWC transmitter 10 comprises a first light source driver 21 arranged to generate a positive unipolar first drive signal 22 for driving the first light source 20, this is accomplished by mapping a first unipolar half 41 of a bipolar modulated first data signal 40 onto a positive unipolar signal, thereby generating the first drive signal 30. The first unipolar half of the bipolar modulated first data signal occupies a first bandwidth range below a first frequency.

Further provided is a second light source driver 31 arranged to generate a positive unipolar second drive signal 32 for driving the second light source 30, by mapping a second unipolar half 42 of the bipolar modulated first data signal 40 onto a positive unipolar signal, thereby generating the second drive signal 32.

FIGS. 1B, 1C and 1D show graphs illustrating the construction of the first and second drive signal in more detail. FIG. 1B shows an exemplary section of a bipolar modulated first data signal 40 encoded using a Manchester line code. Here the first unipolar half 41 of a bipolar modulated first data signal 40, that is the positive components, are mapped onto the positive unipolar first drive signal 22 depicted in FIG. 1C. Likewise, the second unipolar half 42 of the bipolar modulated first data signal 40 as depicted in FIG. 1B is inverted and mapped onto the positive unipolar second drive signal 32 shown in FIG. 1D.

Referring again to FIG. 1A, the light output by the first and second light sources 20 and 30 is transmitted to the OWC receiver 50. The OWC receiver 50 comprises: a first light transducer 60 arranged to detect light at the first wavelength 12 and generate a first electrical detection signal 61; and a second light transducer 70 arranged to detect light at the second wavelength 13 and generate a second electrical detection signal 71.

The OWC receiver further comprises a first signal reconstruction unit 80 arranged to generate a first received signal 81, the first signal reconstruction unit arranged to combine: the first electrical detection signal 61 within the first bandwidth range below the first frequency f_{threshold} as a first component 62 with a first polarity with the second electrical detection signal 71 as a second component 72 with a second polarity, the first polarity opposite to the second polarity, thereby forming the first received signal 81 for output by the OWC receiver.

The reconstruction of the first received signal 81 is depicted in FIGS. 1E, 1F and 1G. FIG. 1E depicts the first electrical detection signal 61 resulting from the detection of the light from the first light source 20. Likewise, FIG. 1F depicts the second electrical detection signal 71 resulting from the detection of light emitted by the second light source 30.

The first signal reconstruction unit 80 maps the first electrical detection signal 61 onto the first component 62 with the same polarity and maps the second electrical detection signal 71 onto the first component 72, by inverting the polarity.

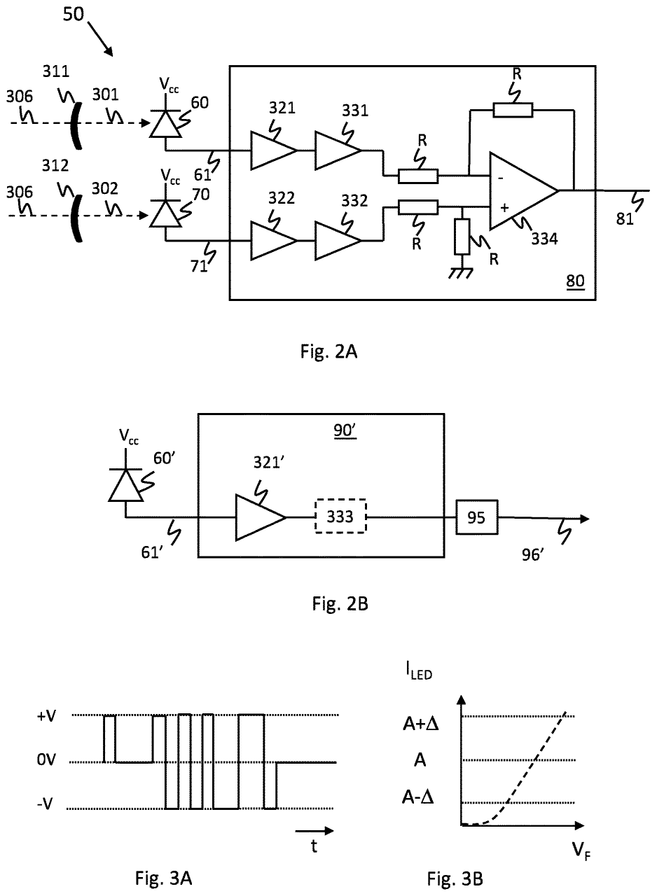

Now referring to FIG. 2A which shows a block diagram of the receiver path implementation of a an exemplary OWC receiver 50. Starting on the left-hand side, we see light 306 from an OWC transmitter as described above, arriving at the OWC receiver 50. Although two distinct beams are depicted, this is for illustration purposes only as in general the OWC receiver 50 will, when placed in the OWC transmitter's coverage area receive a mix of both wavelengths. A portion of light 306 impinging on the OWC receiver 50, passes through a first wavelength selective filter 311 arranged to pass light of a first wavelength 301, but not the second wavelength 302 and a second portion of light 306 passes through a second wavelength selective filter 312 arranged to pass light of a second wavelength 302, but not the first wavelength 301. Effectively demultiplexing the wavelength division multiplex arriving at the OWC receiver 50.

The light having the first wavelength is subsequently passed on to a first light transducer, which may take the form of a photodiode, a phototransistor, or other commonly used light detector sensitive to the first wavelength. Likewise light having the second wavelength is passed on to a second transducer sensitive to the second wave length. Due to the presence of the wavelength selective filters, the transducers may be transducers that are sensitive to a fairly wide range of wavelengths, possibly even sensitive to both the first and second wavelengths, as the wavelength separation is handled by the filters.

The resulting first electrical detection signal 61 from the first transducer 60 and the second electrical detection signal 71 from the second transducer 70 are subsequently passed on to the first reconstruction unit 80. The first reconstruction unit 80 depicted here, was designed for use with signals having discrete modulation levels, such as 10BASE-T and 100BASE-TX signals. The first electrical detection signal 61 and the second electrical detection signal 71 are passed on to respectively the first and second Trans-Impedance Amplifier 321, 322.

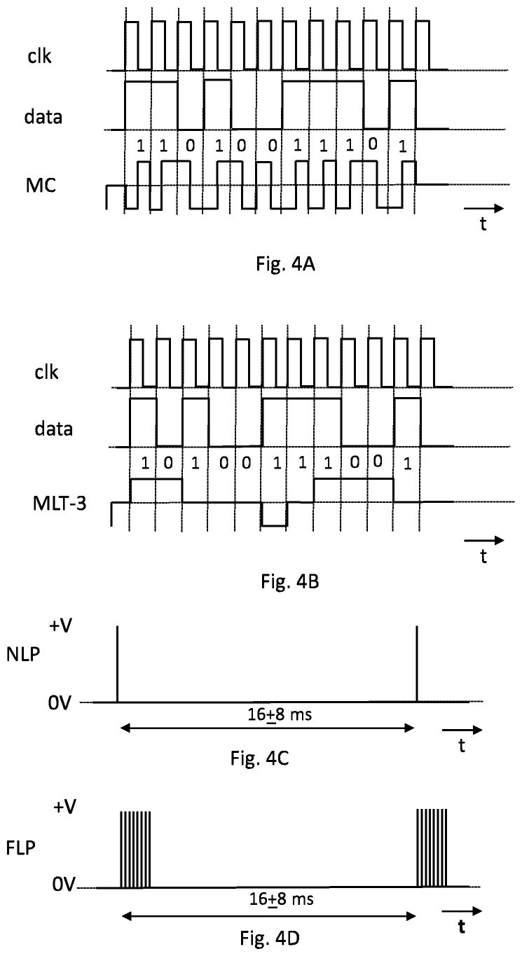

When the bipolar input signal has 2 or three discrete levels such as in case of a 10BASE-T or 100BASE-TX signal, the linearity of the signals is less critical. The 10BASE-T line code essentially has two levels, three, when also counting the idle state (0V). In case of a 10BASE-T signal, the Manchester code thus essentially has three discrete levels, one being the absence of signal (see FIGS. 3A and 4A). In case of a 100BASE-TX signal a MLT-3 line code is used that also has three discrete levels. As shown in FIG. 2A, it is possible to leverage knowledge of the incoming signal modulation in the first reconstruction unit 80 by subsequently passing the TIA outputs to respective limiters 331, 332 that slice the presumed unipolar TIA outputs into two discrete levels and map those to the actual desired voltage levels corresponding with a two-level discrete unipolar signal.

The thus “limited” signals are subsequently summed in an operational amplifier 334 configured using a circuit with resistors R to reconstruct the 10BASE-T or 100BASE-TX signal. Due to the use of a discrete level line code, the system becomes insensitive to non-linearities in the input and/or noise. However, in situations where linearity is key, the outputs from the TIAs 321, 322 may be passed through a gain control stage, or even frequency-dependent equalization stage, in order to compensate for differences in sensitivity from the respective light transducers for the respective wavelengths and/or to compensate for frequency dependent differences in sensitivity.

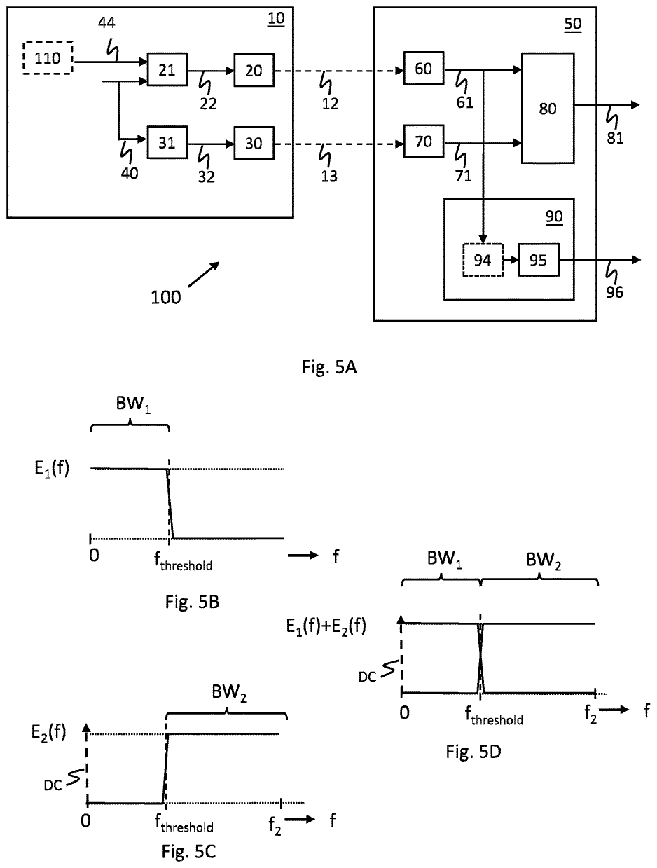

Turning now to FIG. 5A, FIG. 5A depicts a block diagram of a more advances OWC system 100 having a unidirectional communication path for conveying a bipolar modulated first data signal and a unipolar OFDM modulated second data signal. In this OWC system 100, the bipolar modulated first data signal is transmitted and reconstructed in a manner analogous to that described with reference to FIG. 1A. The OWC transmitter 10 depicted in FIG. 5A further conveys the unipolar OFDM modulated second data signal. As described hereinabove, a wide variety of unipolar OFDM modulation schemes are known to those skilled in the art and for this reason will not be further elaborated on here.

In comparison with the OWC system of FIG. 1A, the first light source driver 21 for generating the first drive signal 32 in FIG. 5A is arranged to combine, the first unipolar half of the bipolar modulated first data signal mapped on a positive unipolar signal with a unipolar OFDM modulated second data signal 44 located in a second bandwidth range above the first frequency, thereby creating a frequency division multiplexed signal as shown in FIG. 5D. As indicated the OWC transmitter 10 may receive the unipolar OFDM data signal from an external OFDM modulator, or alternatively a first OFDM modulator 110 may be included within the OWC transmitter 10.

The OFDM modulator 110 provides a unipolar OFDM modulated signal 44. It will be clear to those skilled in the art, that when using DCO-OFDM, the OFDM modulator 110 will first generate a bipolar OFDM signal and will subsequently add a DC-offset to the output, to generate the unipolar OFDM modulated signal 44. The situation may be different when the unipolar OFDM modulated signal 44 is an ACO-OFDM signal.

Turning to FIG. 5B, this schematically depicts that the signal energy of the bipolar modulated first data signal 40, which is substantially located within the first bandwidth range BW₁ extending above 0 Hz to f_{threshold}. Because the 10BASE-T and 100BASE-TX line codes are DC free, the DC component is 0.

Meanwhile the signal energy of the unipolar OFDM modulated second data signal 44, is depicted in FIG. 5C, here in the form of a DCO-OFDM signal. As can be seen the actual energy content of the actual signal is substantially located within the second bandwidth range BW₂ extending upward from f_{threshold} to f₂. Notably also included is a DC component, being the DC offset of the DC-OFDM signal. However, because the 10BASE-T and 100BASE-TX line codes are DC free, the presence of the DC component in the unipolar OFDM modulated second data signal can be filtered out and does not cause issues. FIG. 5D in turn schematically depicts the signal energy of the frequency division multiplex, that is the first 22.

As can be seen the DCO-OFDM modulated second data signal does not have any significant energy within the first bandwidth range BW₁ (other than the DC offset, which is merely an offset and not data). The OFDM signal is preferably generated by means of the bit-loading process during the actual OFDM modulation; more specifically the bit-loading may be adapted, so as not to load bits on the OFDM subcarriers within the first bandwidth range BW₁. Notably modulation standards such as G.vlc (ITU-T G.9991), which is based on G.hn already provides a flexible per subcarrier bit-loading mechanism typically used to accommodate for channel fading.

The frequency division multiplex shown in FIG. 5D contains contributions from both the first and second data signal, the schematic representation shown in FIG. 5D does not properly reflect the actual energy distribution over frequency. When using a frequency division multiplex, it is important that the available dynamic range of the light source transmitting the frequency division multiplex is used as efficiently as possible. Because two signals are frequency division multiplexed on to the first drive signal of the first light source, one can decide which fraction of the available range is allocated to which signal. An important consideration here is that the second data signal, i.e. the OFDM signal preferably is mapped onto the linear range of the voltage-current curve.

Apart from the amplitude, also the actual signal distribution over the bandwidth may be considered, to find a balance. In practice the respective energy contributions of the first and second data signal may be weighted differently, thereby allocating a different part of the total available transmit energy to the first and second data signal, depending on the system requirements, such as required SNR for the first data signal (e.g. 10BASE-T/100BASE-TX channel) and the SNR and thereby data rate to be achieved for the second data signal.

Returning to FIG. 5A, a further difference between FIG. 1A and FIG. 5A may be found in the reception path within the OWC receiver 50. The OWC receiver 50 further comprises a second signal reconstruction unit 90, the second signal reconstruction unit 90 is arranged to pass the first electrical detection signal 61 within the second bandwidth range BW₂ above the first frequency f_{threshold} towards an OFDM demodulator 95, the OFDM demodulator 95 in turn is arranged to retrieve a second received signal 96, when present in its input, from the first electrical detection signal 61 within a second bandwidth range BW₂ by demodulating the OFDM modulation, thereby forming the second received signal (96) for output by the OWC receiver.

The second reconstruction unit 90, may further comprise a first signal processing stage 94. The signal processing stage may comprise a high-pass filter to filter out any residual signal energy present in the first bandwidth range and/or an equalizing filter, that may be used to compensate for frequency dependent non-linearities introduced by the first light-source 20 and the first light transducer 60, thereby improving linearity of the signal passed to the OFDM demodulator 95.

In view of the fact that the first electrical detection signal 61 is essentially a frequency division multiplex, it may be beneficial to further provide a notch filter in the first signal reconstruction unit 80 to filter out any DC component and a low pass filter to remove or substantially attenuate any remnants of the unipolar OFDM signal present in the first electrical detection signal 61 passed to the first signal reconstruction unit.

In FIG. 5A both the first reconstruction unit 80 and the second reconstruction unit 90 use the first electrical detection signal 61 as output by the first light transducer 60. Although this is a viable implementation, alternative implementations are envisaged. For example, instead of using the solution as presented in FIG. 5A, one might instead make use of the OWC receiver 50 as presented with reference to FIG. 1A and complement this with the unipolar modulated OFDM reception path as presented in FIG. 2A.

FIG. 2A depicts a reception path comprising a third light transducer 60′ arranged to detect light at the first and the second wavelength and to generate a third electrical detection signal 61′. To this end the third light transducer is implemented using a broadband light transducer capable of receiving light at both the first and second wavelength. The third electrical detection signal 61′ may be subsequently fed to a third signal reconstruction unit 90′ arranged to amplify the detection signal using a Trans-Impedance Amplifier TIA 321′ and then pass the resulting signal to an OFDM demodulator 95. The OFDM demodulator is arranged to retrieve a third received signal 96′, when an OFDM modulated signal is present, from the third electrical detection signal 61′ within the second bandwidth range by demodulating the OFDM modulation.

In order to prevent that noise and/or other signals affect OFDM demodulation (e.g. components resulting from the bipolar modulated first data signal), preferably, a signal processing stage 333 is provided, which may for example include a band pass filter, that passes signal components within the second bandwidth range and/or a frequency dependent equalizer, in order to compensate for non-linearities introduced by the first light source and/or by the first light transducer.

### Characteristics and Advantages of 10BASE-T and 100BASE-TX

As discussed hereinabove, preferably the bipolar modulated first data signal is one of a 10BASE-T and 100BASE-TX modulated signal. In case a 10BASE-T signal is used, the signal uses a Manchester line-code. FIG. 4A shows an example of a Manchester encoded data sequence. The Manchester code, also known as phase encoding, is a well-known line code used in communications and data storage in which each data bit as shown below the line marked data is encoded either as a “high then low” symbol (0) or “low then high” symbol (1) as shown on the line marked MC, during respective clock periods as shown on the line marked clk. Advantageously, a Manchester signal is self-clocking (on account of the transitions) and has no DC component.

In case a 100BASE-TX signal is used the signal uses a so-called Multi-Level Transmit-3, or MLT-3 line code, an example of which is depicted in FIG. 4B. The MLT-3 line code uses three discrete voltage levels, −1, 0 and +1 as shown on the line marked MLT-3. MLT-3 cycles sequentially through the voltage levels −1, 0, +1, 0. When encoding a 1 bit, it moves to the next state, whereas when encoding a 0 bit, it remains in the same state.

Although the 10BASE-T and 100BASE-TX signals make use of discrete levels, it is further noted, that when no signal is present, the signal defaults to the OV level. When idle, both 10BASE-T and 100BASE-TXT provide pulses, the so-called Normal Link Pulse (NLP) and Fast Link Pulses (FLP) respectively that are used for the auto negotiation phase and self-adaptation of an Ethernet device to the correct protocol.

FIGS. 4C, 4D show exemplary timing diagrams of the idle period for 10BASE-T and 100BASE-TX signals. As can be seen in FIGS. 4C and 4D, in idle mode the NLP and FLP pulses are positive pulses +V, but other than that the signal level is kept at 0V.

This renders the OWC transmitter 10 as depicted in FIG. 1A and FIG. 5A as particularly energy efficient, as the signal level of 0V for both 10BASE-T and 100BASE-TX would not trigger light emissions by the light sources 20 and 30. In fact only the light source emitting positive components of the bipolar modulated first data signal 40 would be triggered to emit light in response to the NLP and FLP pulses, thereby further contributing to low-power operation in the event the 10BASE-T and 100BASE-TX signals are idle.

### Bidirectional Communication Path

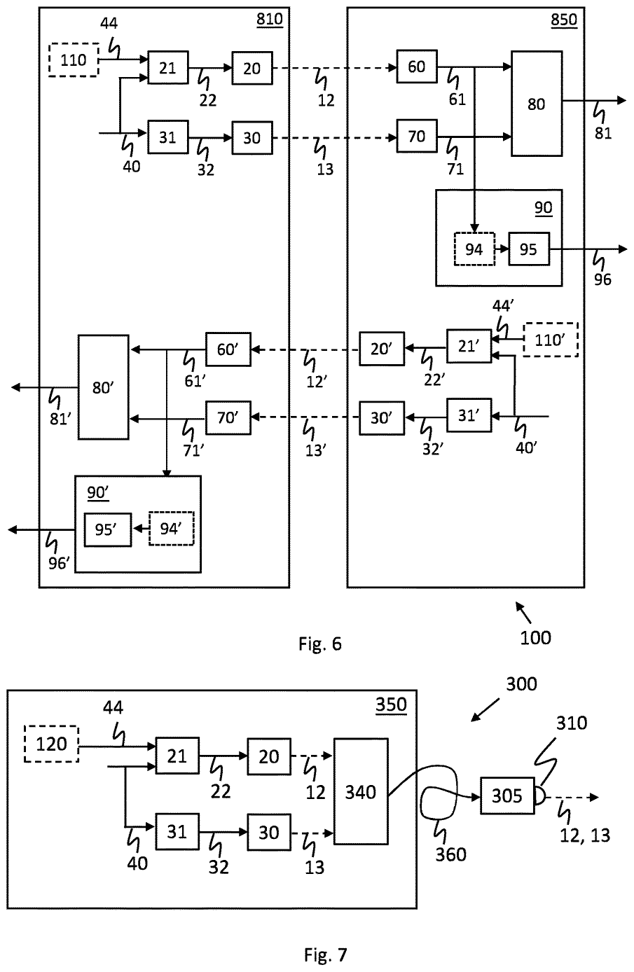

Although the OWC transmitters and OWC receivers discussed herein above all made use of a unidirectional data communication path, it will be clear to those skilled in the art, that the present invention is not limited thereto. As shown in FIG. 6, the present invention may also be used for implementing an OWC system 100 wherein we have a first OWC transceiver 810 and a second OWC transceiver 850 communicating with one another in a bidirectional fashion.

Within the OWC system 100 of FIG. 6, the top transmit-receive path, where data is communicated from left to right is analogous to the transmit-receive path as discussed herein above with reference to FIG. 5A. The bottom transmit-receive path in turn mirrors the respective building blocks, but essentially includes the same building blocks, as evidenced by the use of reference numerals <number> in the top transmit-receive path and <number>′ in the bottom transmit-receive path to designate blocks of similar function.

FIG. 6 depicts discrete unipolar OFDM modulators 110 and 110′ and discrete OFDM demodulators 95 and 95′. Although it is possible to implement the system in this manner, it is often preferred to combine the OFDM modulator and OFDM demodulator functions in devices into a single building block for efficiency reasons. And on this token, the OFDM modulator 110 may be combined with the OFDM demodulator 95′ into a first OFDM modem (not shown) in the first OWC transceiver 810. Likewise, the OFDM modulator 110′ and the OFDM demodulator 95 may be combined into a second OFDM modem (not shown) in the second OWC transceiver 850.

### OWC Transmit Assembly with a Passive Optical Front-End

The OWC transmitters described hereinabove, generally used active OWC transmitters that included the actual light sources and light source drivers. In certain situations, it may be beneficial to utilize an OWC transmit assembly that redistributes the components in a different manner and thereby enables implementation of a passive optical transmit front-end.

Turning to FIG. 7, we here see an OWC transmit assembly 300 that comprises (from right to left), an optical front-end 305 arranged to pass light received from a second optical wireline interface 360 towards a coverage area by means of a lens 310. The second optical wireline interface 360 in turn receives its input from a second OWC transmitter 350. In this manner, when using a unidirectional OWC transmit assembly as shown, it is possible to create a fully passive optical front-end. When the optical wireline interface 360 is implemented as a POF, such a system may be integrated in emergency tents, in containers and/or other facilities that allow deployment in the field.

The second OWC transmitter 350 in turn comprises a first light source 20 for transmitting light at a first wavelength 12 and a second light source 30 for transmitting light at a second wavelength 13, the first wavelength 12 and the second wavelength 13 being different wavelengths. A coupler 340 is provided arranged to couple the light from the first light source 20 and light from the second light source 30 into the second optical wireline interface 360.

The second OWC transmitter 350 further comprises a first light source driver 21 for generating a positive unipolar first drive signal 22 for driving the first light source 20, the first light source driver 21 arranged to combine: a first unipolar half 41 of a bipolar modulated first data signal 40 as a first positive unipolar signal, the first unipolar half 41 of the bipolar modulated first data signal occupying a first bandwidth range below a first frequency; with a unipolar OFDM modulated second data signal 44 located in a second bandwidth range above the first frequency; and a second light source driver 31 for generating a positive unipolar second drive signal 32 for driving the second light source 30, the second light source driver arranged to generate the second drive signal by mapping a second unipolar half 42 of the bipolar modulated first data signal 40 onto a positive unipolar signal, thereby creating the second drive signal 32.

Preferably, the second OWC transmitter 350 further comprises a second OFDM modulator 120 arranged to generate the unipolar OFDM modulated second data signal 44 through the application of bit-loading in the second OFDM modulator, and where no bits are loaded on the OFDM subcarriers within the first bandwidth range.

Further refinements and adaptations as described herein above with reference to FIGS. 1A, 2A and 5A may also be applied to the OWC transmitter 350.

### OWC System Using Three Light Sources

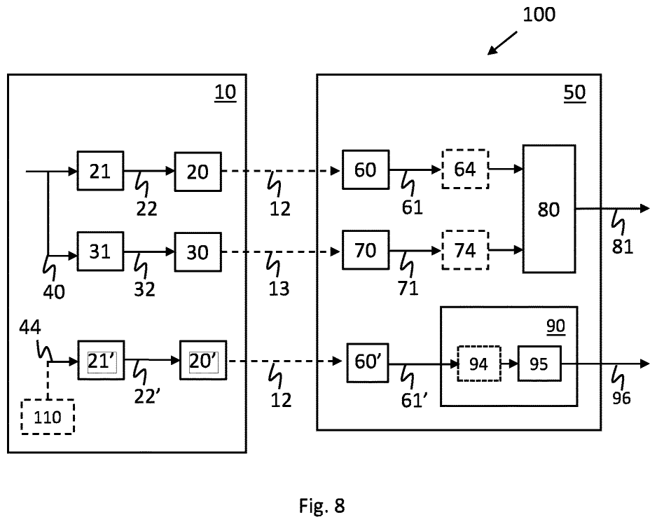

Turning now to FIG. 8, FIG. 8 depicts a further variation of the OWC system 100, wherein on the left-hand side we have an OWC transmitter that is communicating using a uni-directional optical link with the OWC receiver 50.

The OWC transmitter (10) comprises a first light source 20 arranged to transmit light at a first wavelength 12; and a second light source 30 arranged to transmit light at a second wavelength 13. Again, the first wavelength and the second wavelength are different wavelengths. The OWC transmitter further comprises a first light source driver 21 arranged to generate a positive unipolar first drive signal 22 for driving the first light source 20, by mapping a first unipolar half 41 of a bipolar modulated first data signal 40 onto a positive unipolar signal thereby generating the first drive signal 30, the first unipolar half of the bipolar modulated first data signal occupying a first bandwidth range below a first frequency. Similar to the OWC system of FIG. 1A, the OWC transmitter also comprises a second light source driver 31 arranged to generate a positive unipolar second drive signal 32 for driving the second light source 30, by mapping a second unipolar half 42 of the bipolar modulated first data signal 40 onto a positive unipolar signal, thereby generating the second drive signal 32.

Different from the OWC system of FIGS. 1A and 5A, the OWC system 100 of FIG. 8 includes a third light source driver 21′ and a third light source 20′. The third light source driver 21′ arranged to generate the third drive signal 22′ that is based on a unipolar OFDM modulated second data signal 44 located in a second bandwidth range BW₂ above the first frequency. Similar to the situation described in relation to FIG. 5A above, the unipolar OFDM modulated second data signal 44 may optionally be generated by a first OFDM modulator comprised in the OWC transmitter or may alternatively be generated by an external OFDM modulator. The third drive signal 22′ is subsequently passed to a third light source 20′ arranged to transmit light at a first wavelength 12.

The OWC transmitter 10 of FIG. 8 thus creates the frequency division multiplex of light at the first wavelength and in a different manner than the transmitters in FIGS. 1A and 5. The advantage of using a third light source for transmitting the unipolar OFDM second data signal is that, in contrast to the solution in FIG. 5, here the first and second data signal do not need to be mapped within the available power-budget of the first light source. The transmit power used for the first and second data signal in FIG. 8 can be independently varied, at all times keeping in mind eye safety and the light source operating conditions.

The OWC System 100 of FIG. 8 also includes the OWC receiver 50 which comprises a first light transducer 60 arranged to detect light at the first wavelength 12 and generate a first electrical detection signal 61; and a second light transducer 70 arranged to detect light at the second wavelength 13 and generate a second electrical detection signal 71.

Similar to the OWC receiver path depicted with reference to FIG. 2A, the OWC receiver of FIG. 8 includes a broadband third transducer 60′ arranged to detect light at the first wavelength 12 and generate a third electrical detection signal 61′.

The first and second transducers are arranged to detect light of either the first or the second wavelength, but not both wavelengths, in line with the system as described with reference to FIG. 1A. However, in the receive paths in FIG. 8 we see that optionally a second signal processing stage 64 and/or optionally a third second signal processing stage 74 are provided. These respective stages when present preferably comprise a respective TIA (not shown) and a subsequent filter stage arranged to filter out undesirable frequency components. It will be clear to those skilled in the art, that this is more relevant for the first electrical detection signal 61, as it is detected using the first light transducer 60 that is also sensitive to light emitted by the third light source 20′. When no separate signal processing stage is present in the reception path, the TIA may instead be in the first reconstruction unit 80. Provided that the second light transducer is sufficiently insensitive to light from the first wavelength a third signal processing stage 74 may not be required.

The OWC receiver 50 in FIG. 8, further comprises a second signal reconstruction unit 90, similar to that as described with reference to FIG. 5A, the second signal reconstruction unit 90 arranged to pass the third electrical detection signal 61′ within the second bandwidth range above the first frequency to an OFDM demodulator 95, the OFDM demodulator 95 arranged to retrieve a second received signal 96′, when present, from the first electrical detection signal 61′ within the second bandwidth range by demodulating the OFDM modulation, thereby forming the second received signal 96′ for output by the OWC receiver 50. Optionally the second reconstruction unit 90 may include a first signal processing stage 94 as described above.

### Eye Safety

When dealing with optical wireless communication, eye safety remains an important constraint as it limits the transmit power of the OWC transmitter, this applies for visible, infrared and ultraviolet light emissions. The OWC transmitters need to ensure that the total emissions remain within the applicable eye safety regulations, moreover, because the OWC transmitters in accordance with the invention include multiple light sources, we need to account for the total energy contribution of all light sources.

### SUMMARY

Summarizing the present application provides an OWC system, an OWC transmitter and an OWC receiver aimed at power efficient optical wireless communication. To this end an OWC system is proposed to transmit a bipolar first data signal, such as a 10BASE-T or a 100BASE-TX ethernet signals as customary used for twisted pair ethernet, by mapping the positive and negative components of the bipolar signal onto two unipolar drive signals, for driving two separate light sources operating at different wavelengths.

In this manner a low-cost, low-complexity power efficient signal transmission is enabled, that provides a wavelength division multiplex of a bipolar signal, a system that allows reconstruction of the bipolar first data signal at the OWC receiver side, by wavelength division demultiplexing of the transmitted components and re-combining the negative and positive components at the receiver side. Advantageously, this way of working results in a system that, when idle, automatically defaults to a low-power mode of operation, where sync pulses are transmitted only by one of the light sources.

Because this communication channel can be implemented in a limited first bandwidth range, it is moreover ideally suited for having at least one of the positive and negative components of the bipolar signal being frequency division multiplexed with a unipolar OFDM modulated signal, such as a DCO-OFDM signal, where the OFDM modulator utilizes bit-loading to inhibit the use of first bandwidth range in the OFDM signal. This way-of-working provides a unique combination of a wavelength division multiplex transmitter, with a frequency division multiplex transmitter.

When only a single unipolar OFDM modulated second data signal is embedded in the output of one of the light sources, the OWC receiver may use a wide-bandwidth light transducer capable of receiving both wavelengths. This beneficially suppresses the DC signal of the 10BASE-T/100-Base-TX signal, because both wavelength components are received by the wide-bandwidth light transducer.

More optionally, a unipolar OFDM modulated second data signal is embedded in the output of a first light source as a frequency division multiplex as described above, while and a unipolar OFDM modulated third data signal is embedded in the output of the second light source as a frequency division multiplex as described above. To recover both OFDM signals at the receiver-side, the light transducers need to be fitted with wavelength selective filters, so as to be able to perform the wavelength division demultiplexing. The wavelength demultiplexing is effectuated in the optical domain and once the wavelength separation is sorted, this is followed by the frequency division demultiplexing in the electrical domain. Once the frequency division demultiplexing has been completed the bipolar 10BASE-T or 100BASE-TX bipolar first data signal may be reconstructed using the two components in the first bandwidth range, moreover by frequency division demultiplexing the second and third data signal may be extracted and demodulated using either two SISO OFDM demodulators, or a 2-channel MIMO demodulator.

Finally, instead of transmitting a unipolar OFDM signal over one of the light sources, in an alternative OWC system, a bipolar modulated first data signal is combined with a bipolar OFDM modulated signal. In this situation, the positive components of the bipolar modulated first data signal in a first bandwidth range and the positive components of the bipolar modulated OFDM second data signal are combined into a frequency division multiplexed unipolar first driving signal for a first light source outputting light at a first wavelength. Next the negative components of the bipolar modulated first data signal in a first bandwidth range and the negative components of the bipolar modulated OFDM second data signal are combined into a frequency division multiplexed unipolar second driving signal for a second light source outputting light at a second wavelength. Both signals are subsequently transmitted and passed-on towards a first and second light transducer of a OWC receiver. The OWC receiver uses the first light transducer to receive light at the first wavelength, but not the second wavelength, and the second light transducer to receive light at the second wavelength, but not the first wavelength. The transducers thus separate the wavelength division multiplex in the optical domain. As described before, frequency division demultiplexing is applied in the electrical domain. Here, a first reconstruction unit is arranged to combine positive and negative components in the first bandwidth range in order to reconstruct first received signal (which may be a 10BASE-T or 100BASETX signal). A second reconstruction unit in turn is arranged to combine the positive and negative components the received electrical signals in the second bandwidth range into a reconstructed bipolar OFDM signal and feed the reconstructed bipolar OFDM signal to an OFDM demodulator, thereby recovering a second received signal.

### Use of Controller Hardware

In order to control the transmission and the reconstruction/reception in the OWC transmitter and the OWC receiver each of these devices may be provided with a discrete controller, or a control circuit for orchestrating the operations.

When the OWC transmitter is capable of transmitting in both 10BASE-T and 100BASE-TX, the OWC receiver may be arranged to analyze the first received signal (81) in order to determine the type of signal and subsequently the OWC receiver controller may configure the OWC receiver accordingly. Alternatively, the system may always start up in 10BASE-T mode, allowing the OWC transmitter controller to indicate to the OWC receiver controller when to switch to 100BASE-TX or back to 10BASE-T.

When the system is arranged for bi-directional communication, as described with reference to FIG. 6, the OWC transmitter controller and the OWC receiver control may perform a handshake and can exchange information to wake-up the OFDM transmit/receive paths.

The OWC transmitter and OWC receiver controllers can be implemented in numerous ways, with software and/or hardware, to perform the various functions required. A processor is one example of a controller which employs one or more microprocessors that may be programmed using software (e.g., microcode) to perform the required functions. A controller may however be implemented with or without employing a processor, and also may be implemented as a combination of dedicated hardware to perform some functions and a processor (e.g., one or more programmed microprocessors and associated circuitry) to perform other functions.

Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media such as volatile and non-volatile computer memory such as RAM, PROM, EPROM, and EEPROM. The storage media may be encoded with one or more programs that, when executed on one or more processors and/or controllers, perform the required functions. Various storage media may be fixed within a processor or controller or may be transportable, such that the one or more programs stored thereon can be loaded into a processor or controller.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”.

Any reference signs in the claims should not be construed as limiting the scope.

1. An Optical Wireless Communication, OWC, system comprising an OWC transmitter and an OWC receiver,
the OWC transmitter comprising:
a first light source arranged to transmit light at a first wavelength; and
a second light source arranged to transmit light at a second wavelength, the first wavelength and the second wavelength being different wavelengths;
the OWC receiver comprising:
a first light transducer arranged to detect light at the first wavelength and generate a first electrical detection signal;
a second light transducer arranged to detect light at the second wavelength and generate a second electrical detection signal, the OWC transmitter comprising:
a first light source driver arranged to generate a positive unipolar first drive signal for driving the first light source, by mapping a first unipolar half of a bipolar modulated first data signal onto a positive unipolar signal, thereby generating the first drive signal, the first unipolar half of the bipolar modulated first data signal occupying a first bandwidth range below a first frequency;
a second light source driver arranged to generate a positive unipolar second drive signal for driving the second light source, by mapping a second unipolar half of the bipolar modulated first data signal onto a positive unipolar signal, thereby generating the second drive signal and
the OWC receiver comprising:
a first signal reconstruction unit arranged to generate a first received signal, the first signal reconstruction unit arranged to combine:
the first electrical detection signal within the first bandwidth range below a first frequency as a first component with a first polarity with,
the second electrical detection signal as a second component with a second polarity, the first polarity opposite to the second polarity, thereby forming the first received signal for output by the OWC receiver.

2. (canceled)

3. The OWC system of claim 1, wherein the first light source driver for generating the first drive signal is arranged to combine, the first unipolar half of the bipolar modulated first data signal mapped on a positive unipolar signal with a unipolar OFDM modulated second data signal located in a second bandwidth range above the first frequency.

4. The OWC transmitter of claim 3, wherein the OWC transmitter further comprises a first OFDM modulator arranged to generate the unipolar OFDM modulated second data signal through the application of bit-loading in the OFDM modulator, and where no bits are loaded on the OFDM subcarriers within the first bandwidth range.

5. The OWC transmitter of claim 3, wherein the unipolar OFDM modulated second data signal is an OFDM signal selected from the set of DCO-OFDM, ACO-OFDM, Flip-OFDM, PM-OFDM, ADO-OFDM, ASCO-OFDM and HACO-OFDM.

6. The OWC transmitter of claim 3, wherein the bipolar modulated first data signal is encoded using one of:
a 10BASE-T using a Manchester code in accordance with IEEE802.3i-1990, and
a 100BASE-TX using a Multi-Level Transmit-3 line code, MLT-3, in accordance with IEEE 802.3u-1995 to encode data into the bipolar modulated first data signal.

7. A first OWC transmit assembly, comprising:
the OWC transmitter of claim 3;
a first OFDM modulator arranged to generate the unipolar OFDM modulated second data signal through the application of bit-loading in the first OFDM modulator, and where no bits are loaded on the OFDM subcarriers within the first bandwidth range, and
a first electrical or optical wireline interface coupled to the first OFDM modulator arranged to transmit the unipolar OFDM modulated second data signal to the OWC transmitter for transmission.

8. A second OWC transmit assembly, comprising:
the OWC transmitter of claim 3, the OWC transmitter comprising a coupler, arranged to couple the light from the first light source and light from the second light source into a second optical wireline interface;
the second optical wireline interface for transmitting light from a coupler, to the optical front-end; and
an optical front-end arranged to pass light received from the second optical wireline interface towards a coverage area by means of a lens;
a second OFDM modulator arranged to generate the unipolar OFDM modulated second data signal through the application of bit-loading in the second OFDM modulator, and where no bits are loaded on the OFDM subcarriers within the first bandwidth range.

9. An Optical Wireless Communication, OWC, receiver for use in an OWC system with an OWC transmitter, the OWC receiver comprising:
a first light transducer arranged to detect light at a first wavelength and generate a first electrical detection signal;
a second light transducer arranged to detect light at a second wavelength different from the first wavelength and generate a second electrical detection signal,
a first signal reconstruction unit for generating a first received signal, the first signal reconstruction unit arranged to combine:
the first electrical detection signal within a first bandwidth range below a first frequency as a first component with a first polarity with,
the second electrical detection signal within the first bandwidth range below a first frequency as a second component with a second polarity,
the first polarity opposite to the second polarity, thereby forming the first received signal for output by the OWC receiver.

10. The OWC receiver of claim 9, the OWC receiver further comprising a second signal reconstruction unit, the second signal reconstruction unit arranged to pass the first electrical detection signal within a second bandwidth range above the first frequency to an OFDM demodulator, the OFDM demodulator arranged to retrieve a second received signal, when present, from the first electrical detection signal within the second bandwidth range by demodulating the OFDM modulation, thereby forming the second received signal for output by the OWC receiver.

11. The OWC receiver of claim 9, the OWC receiver further comprising:
a third light transducer arranged to detect light at the first and the second wavelength and to generate a third electrical detection signal;
a third signal reconstruction unit, the third signal reconstruction unit arranged to pass the third electrical detection signal to an OFDM demodulator, the OFDM demodulator arranged to retrieve a third received signal, when present, from the third electrical detection signal within a second bandwidth range by demodulating the OFDM modulation, thereby forming the third received signal for output by the OWC receiver.

12. The OWC receiver of claim 9, wherein the first signal reconstruction unit is arranged to reconstruct a bipolar modulated first data signal, when present, using knowledge that the bipolar modulated first data signal is encoded as one of:
a 10BASE-T using a Manchester code in accordance with IEEE 802.3i-1990, and
a 100BASE-TX using a Multi-Level Transmit-3 line code, MLT-3 in accordance with IEEE 802.3u-1995.

13. The OWC receiver of claim 10, wherein the second signal reconstruction unit is arranged to attenuate signal components of the first electrical detection signal in the first bandwidth range.

14. The OWC receiver of claim 9, wherein the transducers are selected from the set of: photodiodes, phototransistors, avalanche photodiodes and silicon photo-multipliers.

15. A method of transmitting a first Optical Wireless Communication signal the method comprising:
driving a first light source with the first drive signal for transmitting light at a first wavelength;
driving a second light source with the second drive signal for transmitting light at a second wavelength, the first wavelength and the second wavelength being different wavelengths;
generating a positive unipolar first drive signal, the first drive signal comprising a first unipolar half of a bipolar modulated first data signal, the first unipolar half of the bipolar modulated first data signal occupying a first bandwidth range below a first frequency;
generating a positive unipolar second drive signal, the second drive signal based on a second unipolar half of the bipolar modulated first data signal.

16. (canceled)
